(19) United States
(12) Patent Application Publication
(10) Pub. No.: US 2015/0193803 A1
(43) Pub. Date: Jul. 9, 2015

(54) SYSTEMS AND METHODS FOR REDEEMING DISCOUNTS

(71) Applicants: Kamal Zamer, Austin, TX (US); Jayasree Mekala, Austin, TX (US); Praveen Nuthulapati, Austin, TX (US)

(72) Inventors: Kamal Zamer, Austin, TX (US); Jayasree Mekala, Austin, TX (US); Praveen Nuthulapati, Austin, TX (US)

(21) Appl. No.: 14/148,473

(22) Filed: Jan. 6, 2014

(51) Int. Cl. G06Q 30/02

(52) U.S. Cl. CPC G06Q 30/0222; G06Q 30/0238

(57) ABSTRACT

A system and method are provided to collect a user's coupons or discount vouchers. In particular, coupons or discount vouchers may be collected by scanning the paper coupon or discount vouchers. Further, digital coupons or discount vouchers may be collected by searching through a user's communication history, including electronic mails, text messages, browsing history, and the like. The collected coupons or discount vouchers are stored in a depository. The system may search the depository for coupons or discount vouchers that are applicable to a purchase that is about to be made or has been made. The system may redeem the applicable coupons or discount vouchers for the purchase.

### BACKGROUND

1. Field of the Invention

The present invention generally relates to systems and methods for redeeming discounts.

2. Related Art

Coupons or discount vouchers have been used by various merchants to entice consumers to visit the merchants and make purchases. Typically, coupons are sent to the consumers by various means, including paper mails, electronic mails, text messages, online advertisements, and the like. Thus, it may be difficult for consumers to keep track of the various discount vouchers or coupons received from various merchants. In particular, it may be difficult for consumers to figure when and which coupons to use when making purchases. As such, the consumers may miss opportunities for receiving discounts when making purchases. Therefore, there is a need for a system or method that helps managing and redeeming coupons.

### BRIEF DESCRIPTION OF THE FIGURES

FIG. 1 is a block diagram of a networked system suitable for managing and redeeming coupons according to an embodiment.

FIG. 2A is a flowchart showing a process of receiving a coupon by scanning according to one embodiment.

FIG. 2B is a flowchart showing a process of searching user communication history for coupons.

FIG. 3 is a flowchart showing a process for redeeming coupons according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or a method is provided to collect and find user's coupons or discount vouchers. In particular, coupons or discount vouchers may be collected by scanning the paper coupon or discount vouchers. Further, digital coupons or discount vouchers may be collected by searching through a user's communication history, including electronic mails, text messages, browsing history, and the like. The collected coupons or discount vouchers are stored in a depository. The system may search the depository for coupons or discount vouchers that are applicable to a purchase that is about to be made or has been made. The system may redeem the applicable coupons or discount vouchers (also generally referred to as incentives) for the purchase.

In another embodiment, the system may find applicable incentives for a specific purchase by searching through emails and text messages that have been sent to the user in the past including incentives that the user may not have saved or otherwise acted upon. In this way, a user may be able to reduce a cost of a purchase by redeeming one or more incentives the user may not be aware of or have saved in the user's digital wallet or account.

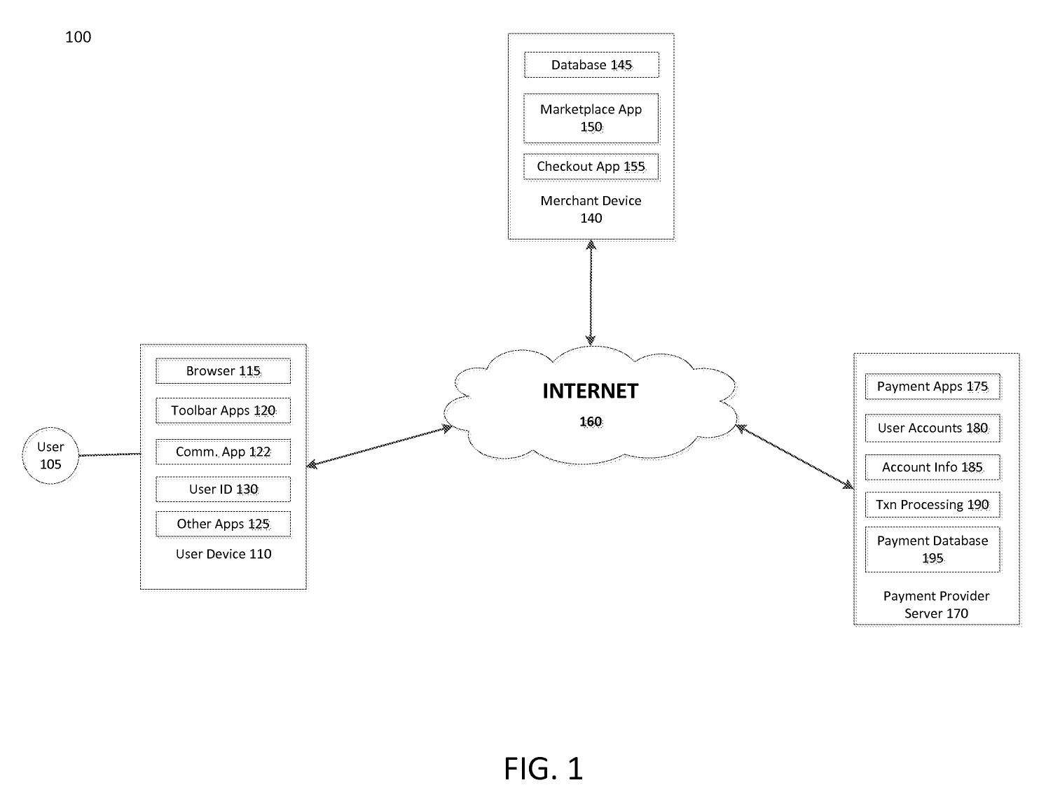

FIG. 1 is a block diagram of a networked system 100 suitable for implementing a process for facilitating purchases using peripheral devices according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one merchant server is shown, a plurality of merchant servers may be utilized if the user is purchasing products or services from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include a camera or a scanner configured to capture images or bar codes of coupons or discount vouchers. For example, user 105 may scan a bar code of a coupon or take a picture of the coupon with user device 110. Thus, user device 110 may convert a physical coupon or discount voucher into a digital one.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a saving account. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant server 140 may generate coupons or discount vouchers for various goods or services offered by the merchant. Merchant server 140 may send the coupons or discount vouchers to user 105 electronically or via postal mail. In some embodiments, coupons or discount vouchers may be distributed at public places, newspapers, magazines, or via social networks. The coupons may include description or codes identifying the coupons and/or indicating the discount condition. For example, the coupons may indicate the merchant that offers the discount, the goods or services to be discounted, the effective time and/or location of the discount, the value of the discount, and the like. The coupons also may be associated with a unique discount code, such as a numerical code or a bar code for identifying the coupons.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

In some embodiments, payment provider server 170 may maintain a coupon repository including collections of coupons associated with each user. The coupons may be redeemed for various purchases to provide discounts for the purchases. For example, user 105's user account may be associated with a plurality of coupons collected by user 105 or by user device 110. The coupons may be organized by merchant, applicable product or services, effective date, amount of discount, or other discount conditions. Payment provider server 170 may periodically update the coupon repositories to add new coupons and remove expired coupons.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

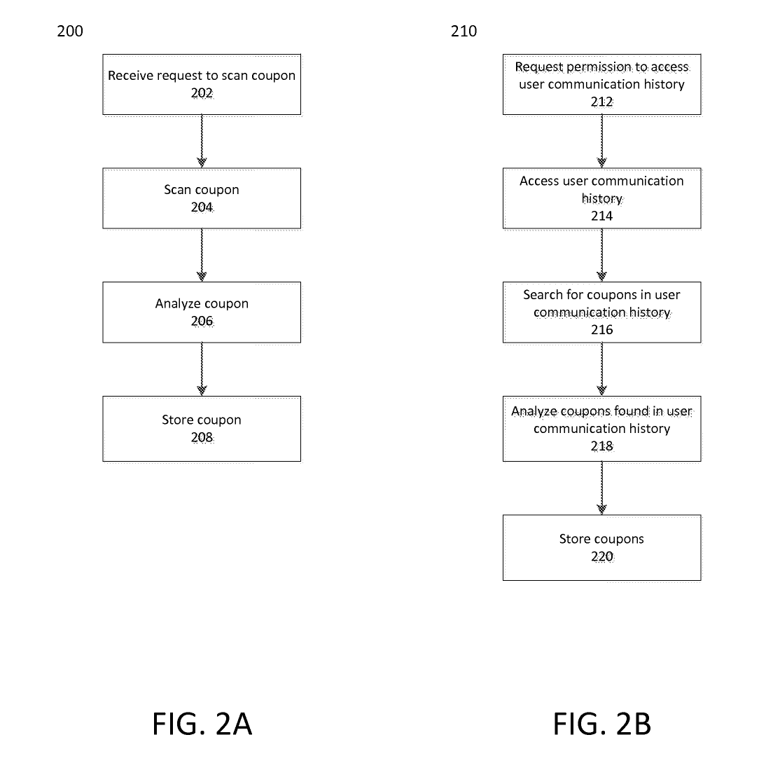

FIG. 2A is a flowchart showing a process 200 for receiving a coupon by scanning according to one embodiment. At step 202, user device 110 may receive a request to scan a coupon. For example, user 105 may activate a camera or a scanner application on user device 110 configured to capture images or specific codes. In response, user device 110 may display images captured by the camera or the scanner on a display screen of user device 110 in real time. Instructions may be displayed or read audibly to user 105 on how to scan a coupon. User 105 may be instructed to point a camera or a scanner of user device 110 toward the coupon in a manner that the coupon is within a view of the camera or the scanner. User 105 may view the display of user device 110 to adjust the position of user device 110 such that the coupon is properly placed within the field of view of the camera or the scanner of user device 110.

At step 204, user 105 may press a “take” button to instruct user device 110 to capture the image of the coupon. In response, user device 110 may capture an image of the coupon or scan a barcode or QR code of the coupon. In some embodiments, the coupons or discount vouchers may be captured from a digital content. For example, when user 105 is viewing a digital content, such as a web page or an electronic message, that includes a coupon, user 105 may instruct user device 110 to capture the coupon from the digital content. In response, user device 110 may capture the image or the barcode or QR code of the coupon included in the digital content. Thus, coupons may be collected from digital contents based on user's instructions.

At step 206, user device 110 may analyze the captured coupon. In some embodiments, user device 110 may send the image or the code of the coupon to payment provider server 170 which may then analyze the image or the code of the coupon. The coupon may include an image of the applicable goods or services. Payment provider server 170 may analyze the image of the applicable goods or services to identify the applicable goods or services or the merchant that offers the applicable goods or services for sale. For example, payment provider server 170 may use image recognition method to read a company logo on the coupon to identify the merchant who issued the coupon. The coupon may include a unique code, such as a barcode or a QR code, that identifies the coupon.

Payment provider server 170 may access a coupon database to identify the coupon and the conditions or restrictions for using the coupon. The coupon also may include texts that describe the coupon and the conditions or restrictions for the coupon. Payment provider server 170 may utilize a text recognition device to read the text and determine the conditions or restrictions of the coupon. For example, payment provider server 170 may determine the applicable goods or services with which the coupon may be used to obtain the discount, the number of items to be purchased to qualify for discount, the effective time period of the coupon, effective geographical location for the coupon, and other restrictions. In some embodiment, payment provider server 170 may verify the coupon with the APIs of the merchant who issued the coupon.

At step 208, payment provider server 170 may store the coupon in a coupon depository associated with user 105's payment account at payment provider server 170. The coupons may be organized by the applicable merchant, the applicable goods or services, the effective time, or other conditions of the coupons. In some embodiments, user device 110 may store the coupons collected by user 105.

By using the above process 200, non-digital coupons, such as paper coupons, coupons in poster or paper advertisements, or the like may be converted into a digital format and stored electronically in a coupon depository or database and associated with a user's account. Thus, various forms of coupons received by a user may be collected and organized.

FIG. 2B is a flowchart showing a process for mining coupons from user communication history. At step 212, user device 110 or payment provider server 170 may request permission to access user 105's communication history. For example, an inquiry: “Allow payment service access to communication history to find coupons?” may be displayed to user 105 at user device 110. Communication history may include user 105's email messages, text messages, browsing history, browsing cookies, Rich Site Summary (RSS) feeds, twitter messages, or the like. User device 110 may provide an interface for user 105 to respond to the inquiry. For example, user device 110 may display virtual “YES” and “NO” buttons for user 105 to select and press. In some embodiments, physical “Y” and “N” buttons also may be provided on user device 110 to receive user 105's response.

At step 214, user device 110 or payment provider server 170 may access the communication history of the user. For example, user device 110 or payment provider server 170 may obtain the login and password information of user 105 for various communication accounts, such as email, tweets, text message accounts, and may log into these communication accounts. User device 110 or payment provider server 170 also may access the browsing history, download history, or cookies of user 105. In some embodiments, user device 110 may send user 105's login and/or password information to payment provider server 170 and payment provider server 170 may access user 105's communication accounts.

Some of the communication history, such as email messages, text messages, browsing history, download history, browser cache, RSS feeds, or the like, may be stored at user device 110 or in a database managed by the payment provider. Communication history, such as old email messages, text messages, or the like, may also or alternatively be stored at third party email or messaging servers. Payment provider server 170 may request user device 110 to search for coupons in the communication history stored at user device 110 or other sources. In some embodiments, when user device 110 receives incoming communication information, user device 110 may scan the incoming communication information for coupons.

In some embodiments, user device 110 may perform coupon scanning periodically. User device 110 may send coupons found in the communication history to payment provider server 170. For the communication history stored at third party server, payment provider server 170 or user device 110 may access the communication history using login or password provided by user 105 and perform coupon scanning for these communication history stored at third party servers.

At step 216, user device 110 or payment provider server 170 may search user 105's communication history for coupons or discount vouchers. For example, words related to coupons such as; “coupon,” “discount,” “sales,” “Specials,” “off,” “money back,” and the like may be searched for in the emails or text messages. Images in the emails or text messages also may be analyzed to find images related to a coupon. For example, text related to a coupon, such as “coupon,” “discount,” “sales,” “Specials,” “off,” “money back,” and the like may be searched for in the images of emails or text messages using text or image recognition techniques. Certain images, such as barcodes or barcodes, embedded in images also may be possible coupons. Text or images in caches or download in user's browsing or download history also may be searched for images or texts related to coupons.

Web cookies also may be searched for cookies that are applicable to provide discount to purchases. In some embodiments, images or videos captured by user device 110 also may be searched and analyze to mine for possible coupons. For example, user device 110 may be a wearable device, e.g., glasses, attached to user 105 and configured to continuously captured images or videos of user 105's surrounding. Thus, user device 110 may capture images of coupons around user 105 and user device 110 may search the capture images or videos to find these coupons.

At step 218, user device 110 or payment provider server 170 may analyze the coupons found in user 105's communication history. For example, the coupon may include an image of the applicable goods or services. Payment provider server 170 may analyze the image of the applicable goods or services to identify the applicable goods or services or the merchant that offers the applicable goods or services for sale. For example, payment provider server 170 may use image recognition method to read a company logo on the coupon to identify the merchant who issued the coupon. The coupon may include a unique code, such as a barcode or a QR code, that identifies the coupon. Payment provider server 170 may access a coupon database to determine the type and condition for the coupon.

The coupon also may include texts that describe the coupon and the conditions or restrictions for the coupon, such as an expiration date or minimum purchase amount. Payment provider server 170 may utilize a text recognition device to read the text and determine the conditions or restrictions of the coupon. For example, payment provider server 170 may determine the applicable goods or services with which the coupon may be used to obtain the discount, the number of items to be purchased to qualify for discount, the effective time period of the coupon, effective geographical location for the coupon, and other restrictions. In some embodiments, payment provider server 170 may verify the coupon with the APIs of the merchant who issued the coupon.

At step 220, user device 110 or payment provider server 170 may store the found coupons in a coupon depository. In particular, the found coupons may be associated with user 105's payment account, such that they may be used to obtain discounts for purchases made by user 105. The coupons may be organized by the applicable merchant, the applicable goods or services, the effective time, or other conditions of the coupons.

By using the above process 200, digital coupons received by user 105 may be automatically collected from user 105's communication history, such as emails, text messages, RSS feeds, tweets, browsing history, download history, and the like, and stored in a coupon depository. Thus, various forms of coupons received by a user may automatically be collected and organized.

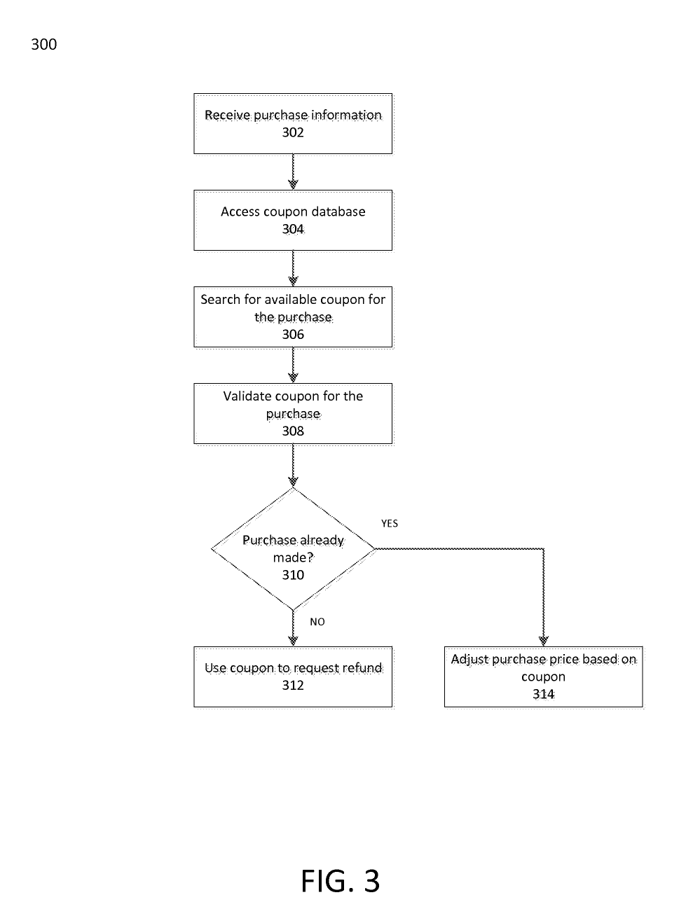

FIG. 3 is a flowchart showing a process for redeeming coupons according to one embodiment. At step 302, payment provider server 170 may receive purchase information. For example, when user 105 makes a purchase using user device 110, user device 110 or merchant device 140 may send a payment request for the purchase along with purchase information to payment provider server 170. The purchase information may include time and location of purchase, identity of the merchant, product and services being purchased including Universal Product Code (UPC), quantity of product being purchased, and any coupons presented to the merchant. The purchase information may be received by payment provider server 170 when user 105 is about to make a purchase at a Point of Sale (POS) at the merchant's store or at the merchant's website. In some embodiments, the purchase information may be received after the purchase has been made. Thus, the coupons may be redeemed when the purchase is being made or after the purchase has been made.

At step 304, payment provider server 170 may access the coupon database for the coupon repository associated with user 105's payment account. As noted above, in steps 208 and 220, coupons received by user 105, either via scanning by user 105 or from user 105's communication history, may be stored in a coupon repository associated with user 105's payment account. Payment provider server 170 may access user 105's coupon repository.

At step 306, payment provider server 170 may search for available coupons in the coupon repository that may be used for the purchase. For example, based on the purchase information, payment provider server 170 may search for coupons that match one or more of the merchant, the product or service being purchase, the geographical location, the amount of the purchase, and/or the quantity of the purchase. One or more matching coupons may be found. In other embodiments, incentives may be searched in addition to or alternatively from the coupon repository. In these embodiments, the payment provider may search a user's email and/or text messages to determine whether any incentives can be applied to the current purchase. For example, the user may have received an incentive through email or text, but did not save or otherwise act on the incentive.

At step 308, payment provider server 170 may validate the matching coupons to confirm they may be redeemed for the purchase. For example, payment provider server 170 may confirm that the matching coupons have not expired and are still effective. Payment provider server 170 also may determine whether the purchase qualify under the coupons' conditions and restrictions. For example, some coupons require that a minimum quantity of goods or service be purchased to qualify for the discount. Some coupons require that they are used only once by the same user. Some coupons may be combined and some may not. Some coupons require that two or more different goods or service be purchased together to qualify for the discount. Sonic coupons exclude certain goods or services. Payment provider server 170 may confirm that the purchase meets the additional conditions or restrictions of the coupons.

One or more coupons may be qualified for the purchase. Payment provider server 170 may determine whether the coupons are combinable. If so, payment provider server 170 may combine the coupons to obtain additional discount for user 105. If the coupons are not combinable, payment provider server 170 may compare the coupons and determine which coupon results in the best discount for user 105 and may select the best coupon to be used for the purchase. In some embodiments, user 105 may be requested to select one or more coupons from a group of qualifying coupons to be applied to the purchase.

At step 310, payment provider server 170 may determine whether the purchase already has been made. For example, process 300 may be executed during a purchase at a POS to find a matching coupon. In some embodiments, process 300 may be executed to find matching coupons for purchases that already have been made.

If the purchase has not been made, payment provider server 170 may redeem the coupon and adjust the final price of the purchase based the coupon. For example, if the coupon allows a 20% off, payment provider server 170 may reduce the price of the purchase by 20%. Thus, payment provider server 170 may automatically redeem the coupon during the purchase to obtain savings for user 105. In some embodiments, payment provider server 170 may note in the coupon repository that the coupon has been used by user 105. As such, based on the coupon's restriction, the coupon may not be reused.

If the purchase has been made, payment provider server 170 may use the coupon to request a refund from the merchant. For example, payment provider server 170 may determine whether the coupon allows for discount to be applied retrospectively after the purchase has been made. If so, payment provider server 170 may determine the difference between the price paid without the coupon and the price paid with coupon. Payment provider server 170 may request reimbursement from the merchant for the difference. Payment provider server 170 may reimburse the difference back to user 105's payment account. Thus, user 105 may benefit from the use of coupon even after the purchase has been made.

By using the above processes 200, 210, and 300, incentives such as coupons or discount vouchers received by a user may automatically be collected and stored in a coupon repository associated with the user's payment account and/or searched for possible use in a current payment transaction. The coupons in both digital and printed form may be collected. In particular, the user's communication history may be searched to mine for coupons embedded in the communication history. Further, the coupon depository automatically is searched to find a matching coupon for a purchase. The coupon may automatically be redeemed to provide saving for the user. If the purchase already has been made, the coupon may be applied retrospectively to obtain refund from the merchant. Thus, the user no longer needs to spend time and effort in collecting and organizing coupons. Further, the user need not figure out which coupon to use when making a purchase, because a matching coupon for the purchase is automatically found and applied to obtain saving for the user. Moreover, the user may shop with confidence, because coupons also may be used to obtain refund for purchases that are already made.

The following are exemplary scenarios in which the above processes 200, 210, and 300 may be implemented.

### Example 1

A user has a payment account registered at a payment service provider for making purchases. The user gives permission to the payment service provider to scan the user's communication history, such as emails, text messages, browsing history, and the like, for coupons and/or store any discovered coupons in a coupon repository. The user is headed to a home appliance store to buy a refrigerator. On the way to the store, the user receives an email from the store including a 30% off coupon. The payment service provider scans the user's email and detects the new 30% off coupon from the home appliance store and stores the coupon in the coupon repository.

The user makes a purchase at the home appliance store. The user uses the payment service provider to make a payment for the purchase. The payment service provider determines that the 30% off coupon is applicable to the purchase. Thus, the payment service provider automatically applies the 30% off coupon to the purchase or presents the coupon to the user to reduce the purchase price by 30%. The payment service provider also discovers a text message that was sent two weeks ago to the user for a $10 off coupon for any purchase at the home appliance store. The discount is shown to the user at the POS terminal of the home appliance store. The payment service provider then marks the 30% coupon as used in the coupon repository. Thus, the user automatically receives the benefit of the 30% coupon and $20 off coupon without having to find the coupons from the user's email and text.

### Example 2

A user recently purchased a new home. The user has a payment account registered at a payment service provider for making purchases. The user gives permission to the payment service provider to scan the user's communication history for coupons and/or store any discovered coupons in a coupon repository. The user recently bought a refrigerator from a home appliance store for $2,000. The purchase was paid for via the payment service provider.

After making the purchase, the user receives an email including a coupon for “10% off all appliances” from the home appliance store. The payment service provider scans the user's emails and discovers the 10% off coupon from the home appliance store and stores the 10% off coupon in the coupon depository. Further, the payment service provider recognizes that the 10% off coupon is associated with the home appliance store. The payment service provider makes an API call to a product information service furnished by the home appliance store to determine if the coupon is applicable to any purchases made in the user's purchase history. The payment service provider determines that the user's purchase of the refrigerator qualifies for the 10% discount of the coupon.

The payment service provider notifies the user of the 10% off coupon and inquires the user whether the coupon should be redeemed to obtain discount for the refrigerator purchase. The user agrees to use the 10% coupon for the refrigerator purchase. Thus, the payment service provider applies the discount from the home appliance store's account to the user's payment account. As such, the user is reimbursed for the 10% of the purchase price, e.g., $200 plus applicable tax difference. Thus, the user is able to redeem a coupon retrospectively after the purchase has been made. The user need not go back to the home appliance store to obtain the discount. The user has great customer experience with the home appliance store and develops customer loyalty toward the home appliance store. Further, the home appliance store conserve time and cost by not having to process a refund for the user. Both the merchant and the user develop loyalty toward the payment service provider for the convenience in the coupon redemption service provided by the payment service provider.

### Example 3

Example 3 may be similar to example 2. In example 3, the 10% off coupon is a paper coupon and the user receives the 10% off coupon via postal mail. In this case, the user uses a mobile device to scan the paper coupon. In particular, a coupon scanning application provided by the payment service provider is executed at the mobile device to scan the paper coupon. The coupon scanning application uses image recognition method to read a company logo on the paper coupon to identify the merchant who issued the coupon. The coupon scanning application uses text recognition method to read the text on the paper coupon, such as the discount conditions and restrictions. Other image recognition methods are used to piece together and reconstruct the coupon. The payment service provider makes an API call to the merchant who issued the coupon to verify the coupon. For example, coupons recently issued by the merchant may be considered to identify the coupon based on the scanned image of the paper coupon. After verifying the coupon, the payment service provider applies the coupon retroactively to the refrigerator purchase made by the user similar to example 2.

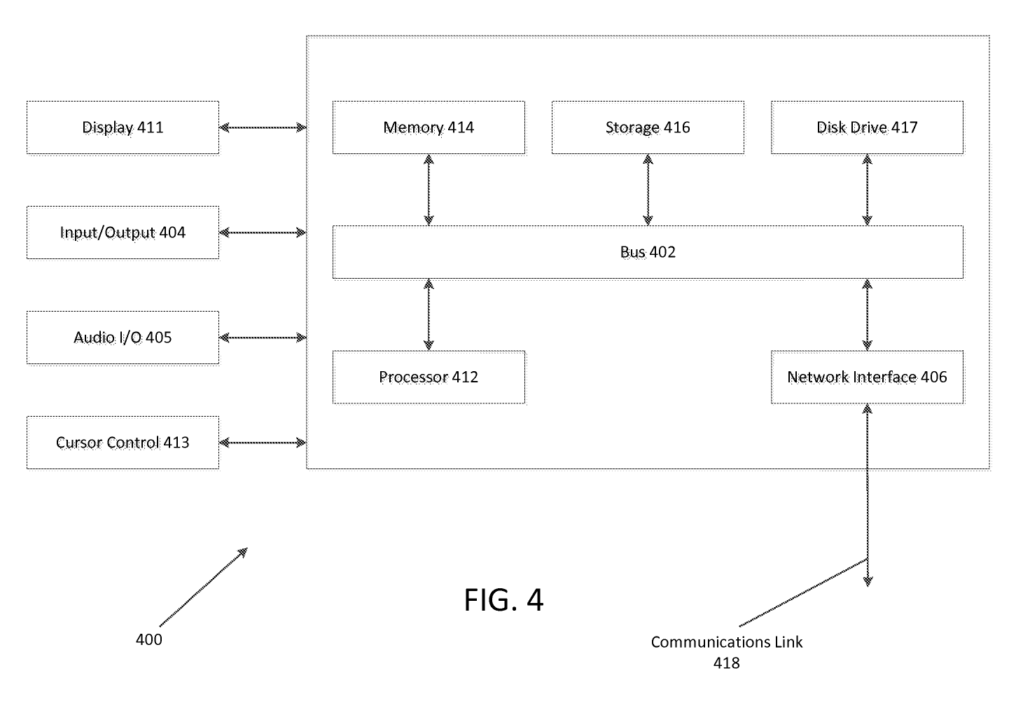

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing information about a payment account of a user;
one or more processors in communication with the memory and adapted to:
receive a payment request for a purchase made using the payment account of the user;
access emails and/or text messages for the user;
determine an incentive from the emails and/or the text messages applicable for the purchase; and
process the payment request using the incentive.

2. The system of claim 1, wherein the one or more processors are further adapted to access and determine an incentive from one or more of browsing history, download history, Rich Site Summary (RSS) feeds, twitter feeds, and browser cache of the user.

3. The system of claim 1, wherein the one or more processors are further adapted to:
verify the incentive with a merchant who issued the incentive; and
analyze the incentive to determine discount conditions and restrictions; and
determine a discount for the purchase based on the discount conditions and restrictions.

4. The system of claim 1,
wherein the incentive is determined before the purchase is made, and
wherein the one or more processors are adapted to:
redeem the incentive for the purchase at a Point of Sale (POS); and
adjust a price of the purchase based on the discount on the purchase.

5. The system of claim 1,
wherein the incentive is determined after the purchase is made, and
wherein the one or more processors are adapted to:
verify with a merchant who issued the coupon that the incentive is retroactive; and
reimburse a price difference of the purchase due to the discount to the payment account of the user.

6. The system of claim 1, wherein the one or more processors are further adapted to:
search communication history of the user for incentives; and
store the incentives found in the communication history in a depository associated with the user.

7. The system of claim 6, wherein the one or more processors are further adapted to:
in response to receiving the payment request for the purchase, determine an incentive applicable to the purchase from the depository, in addition to the incentive determined from the emails and/or the text messages.

8. A method comprising:
receiving, by a processor of a payment provider server, a payment request for a purchase made using a payment account of a user;
accessing, by the processor, emails and/or text messages for the user;
determining, by the processor, an incentive from the emails and/or the text messages applicable for the purchase; and
processing, by the processor, the payment request using the incentive.

9. The method of claim 8 further comprising: accessing and determining an incentive applicable to the purchase from one or more of browsing history, download history, Rich Site Summary (RSS) feeds, twitter feeds, and browser cache of the user.

10. The method of claim 8 further comprising:
verifying the incentive with a merchant who issued the incentive; and
analyzing the incentive to determine discount conditions and restrictions; and
determining a discount for the purchase based on the discount conditions and restrictions.

11. The method of claim 8,
wherein the incentive is determined before the purchase is made, and
wherein the method further comprising:
redeeming the incentive for the purchase at a Point of Sale (POS); and
adjusting a price of the purchase based on the discount on the purchase.

12. The method of claim 8,
wherein the incentive is determined after the purchase is made, and
wherein the method further comprising:
verifying with a merchant who issued the coupon that the incentive is retroactive; and
reimbursing a price difference of the purchase due to the discount to the payment account of the user.

13. The method of claim 8 further comprising:
searching communication history of the user for incentives; and
storing the incentives found in the communication history in a depository associated with the user.

14. The method of claim 13 further comprising:
in response to receiving the payment request for the purchase, determine an incentive applicable to the purchase from the depository, in addition to the incentive determined from the emails and/or the text messages.

15. A non-transitory machine-readable medium comprising a plurality of machine-readable instructions which when executed by one or more processors of a payment provider server are adapted to cause the payment provider server to perform a method comprising:
receiving, by a processor of a payment provider server, a payment request for a purchase made using a payment account of a user;
accessing, by the processor, emails and/or text messages for the user;
determining, by the processor, an incentive from the emails and/or the text messages applicable for the purchase; and
processing, by the processor, the payment request using the incentive.

16. The non-transitory machine-readable medium of claim 15, wherein the method further comprising: accessing and determining an incentive applicable to the purchase from one or more of browsing history, download history, Rich Site Summary (RSS) feeds, twitter feeds, and browser cache of the user.

17. The non-transitory machine-readable medium of claim 15, wherein the method further comprising:
verifying the incentive with a merchant who issued the incentive;
analyzing the incentive to determine discount conditions and restrictions; and
determining a discount for the purchase based on the discount conditions and restrictions.

18. The non-transitory machine-readable medium of claim 15,
wherein the incentive is determined before the purchase is made, and
wherein the method further comprising:
redeeming the incentive for the purchase at a Point of Sale (POS); and
adjusting a price of the purchase based on the discount on the purchase.

19. The non-transitory machine-readable medium of claim 15,
wherein the incentive is determined after the purchase is made, and
wherein the method further comprising:
verifying with a merchant who issued the coupon that the incentive is retroactive; and
reimbursing a price difference of the purchase due to the discount to the payment account of the user.

20. The non-transitory machine-readable medium of claim 15, wherein the method further comprising:
searching communication history of the user for incentives; and
storing the incentives found in the communication history in a depository associated with the user.

21. The non-transitory machine-readable medium of claim 20, wherein the method further comprising:
in response to receiving the payment request for the purchase, determine an incentive applicable to the purchase from the depository, in addition to the incentive determined from the emails and/or the text messages.
